(19) United States
(12) Patent Application Publication
(10) Pub. No.: US 2006/0096557 A1
(43) Pub. Date: May 11, 2006

(54) Monosteel piston having oil drainage groove with enhanced drainage features

(76) Inventors: Ken Christain, Brighton, MI (US); Miguel Azevedo, Ann Arbor, MI (US); Carmo Ribeiro, Ann Arbor, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/239,561

(22) Filed: Sep. 29, 2005

Related U.S. Application Data
(60) Provisional application No. 60/614,818, filed on Sep. 30, 2004.

(51) Int. Cl. F01P 1/04; F02F 3/00

(52) U.S. Cl. 123/41.38; 123/193.6

(57) ABSTRACT

A monobloc piston assembly includes a piston head having a combustion bowl found in an upper surface and a ring belt found with a plurality of ring grooves. An oil cooling gallery is formed in the piston head adjacent the combustion bowl and ring belt. A pair of pin bosses are formed with aligned pin bores and a piston skirt is formed as an immovable piece with the pin bosses. An oil drainage groove is formed below the ring grooves and includes at least one drain hole open to the interior of the piston skirt.

This application claims priority to U.S. Provisional Application No. 60/614,818, filed Sep. 30, 2004.

### BACKGROUND OF THE INVENTION

1. Technical Field

This invention relates to pistons for diesel engine applications.

2. Related Art

For some heavy duty diesel engine applications, a certain amount of mist or vapor is known to be emitted out of the engine breather when the engine is operating under a low idling condition. It is believed that this phenomenon is attributable, in part, due to insufficient oil drainage in the power cylinder. Many heavy duty diesel pistons are fabricated with three ring grooves, the upper two of which accommodate compression rings, and the lower groove accommodating an oil scrapper ring. As the piston reciprocates, oil is scrapped off the cylinder walls down toward the crank case. When the volume of oil increases or if there is an increase in the amount of oil present on the combustion cylinder liner surface against which the piston reciprocates, the traditional approaches to oil drainage may be insufficient. An added challenge arises when the skirt is fabricated as one piece with the upper crown (so-called monobloc piston).

U.S. Pat. No. 6,557,514 discloses a monobloc piston having three ring grooves for accommodating compression and oil scrapper rings, and formed with a fourth groove below the lowest-most oil ring groove that is free of any rings and is present for serving as a relief or depression into which oil scrapped by the rings can enter in an effort to improve the management of oil scrapped from the liner walls. However, while this construction has certain benefits in the management of oil control, under the low idle conditions described above, there were incurrences where the so-called white vapor condition was still present.

It is an object of the present invention to eliminate or greatly minimize the “white vapor” problem and to improve upon prior monobloc pistons, including those employing a fourth oil drainage groove.

### SUMMARY OF THE INVENTION AND ADVANTAGES

A monobloc piston assembly includes a piston head having a combustion bowl found in an upper surface and a ring belt found with a plurality of ring grooves. An oil cooling gallery is formed in the piston head adjacent the combustion bowl and ring belt. A pair of pin bosses are formed with aligned pin bores and a piston skirt is formed as an immovable piece with the pin bosses. An oil drainage groove is formed below the ring grooves and includes at least one drain hole open to the interior of the piston skirt.

The at least one drain hole in the oil drainage groove enhances the oil drainage function of the groove, and particularly by direction excess oil to the interior of the piston, thereby elimination or contributing to a reduction in the occurrence of white vapor.

### THE DRAWINGS

These and other features and advantages of the present invention will become more readily appreciated when considered in connection with the following detailed description and appended drawings, wherein:

FIG. 1 is a perspective view of a piston;

FIG. 2 is a cross-sectional view taken generally along lines 2-2 of FIG. 1;

FIG. 3 is a bottom view of the piston; and

FIG. 4 is a cross-sectional view taken generally along lines 4-4 of FIGS. 1 and 3.

### DESCRIPTION

A monobloc piston constructed according to a presently preferred embodiment of the invention is illustrated generally at 10 in the drawings and includes an upper crown 12 which is united to a lower crown 14 across a joint 16 to provide an at least partially closed oil cooling gallery 18 that is fed from below with cooling oil (not shown) pumped from the vehicle engine through one or more ports 20 extending through a floor 22 of the gallery to direct cooling oil into the gallery during piston operation to cool the upper crown section 12 in known manner.

The piston 10 includes a pair of pin boss sections 26 formed as one piece with the lower crown 14 and supporting a pair of fixed skirt sections 28 which are formed as one piece with the pin boss of the lower crown 14 of the same material. The upper crown 14 includes a combustion bowl 30 that is recessed into an upper surface 32 of the upper crown 12 and forms in part a wall of the oil gallery 18. An outer annular ring belt 34 encircles the oil gallery 18 and extends downwardly from the upper surface 32 of the upper crown 12. The ring belt 34 is formed with a plurality of ring grooves 36 recessed into an outer annular surface 38 of the piston 10 for accommodating a corresponding plurality of piston rings 40. The lowest of the ring grooves comprises an oil ring groove for accommodating an oil scrapper ring 40 or ring set. As illustrated, the piston preferably includes two additional ones of the ring grooves 36 above the lowest of the ring grooves and these preferably accommodate a corresponding pair of compression piston rings 40. This arrangement of oil and compression rings is common to heavy duty piston applications, and a particular size, geometry or type of ring may vary from application to application and thus the invention contemplates in the broad sense that the piston will include at least one oil ring groove and at least on compression ring groove residing above the oil ring groove, but preferably two such compression ring grooves.

The piston 10 is formed with at least one additional groove 42 below the lowest of the piston ring grooves 36 (i.e., below the oil ring groove) which is designed to manage the flow of oil scrapped from the wall of a cylinder in which the piston 10 operates to minimize the passage of oil beyond the piston rings. The oil drainage groove 44 extends around the skirt sections 28 and opens to outer flattened faces 44 of the pin bosses 26, such that the groove 42 is discontinuous in the circumferential direction, unlike the piston ring grooves 36 which are circumferentially continuous. The oil drainage groove 42 may also be shallower in depth than that of the ring grooves 36, although a fourth groove 42 that is shallower or deeper than that illustrated could be employed and is contemplated by the present invention. It will be also seen in FIG. 2 that the oil drainage groove 42 lies generally in the same plane as that of the floor 22 of the oil cooling gallery 18, although it could be higher or lower if desired.

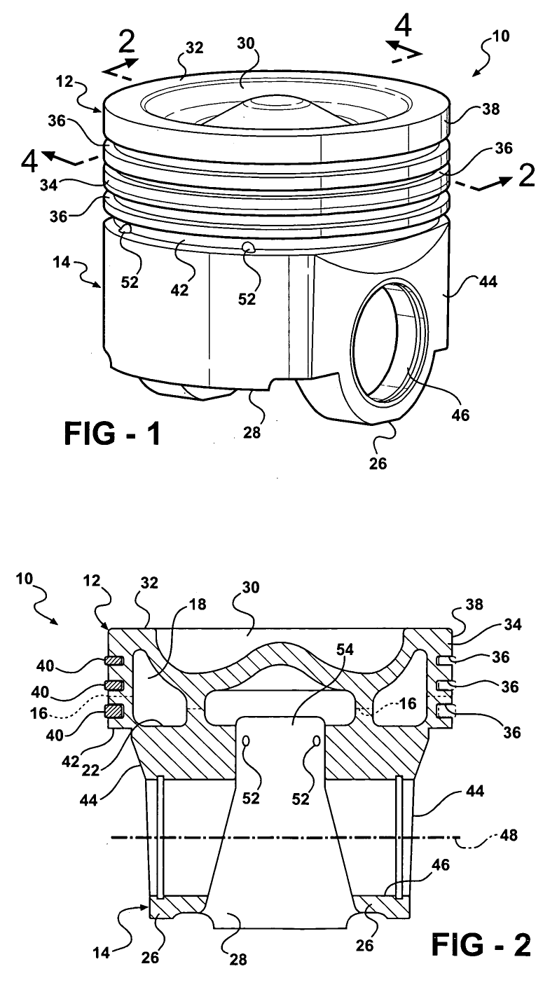

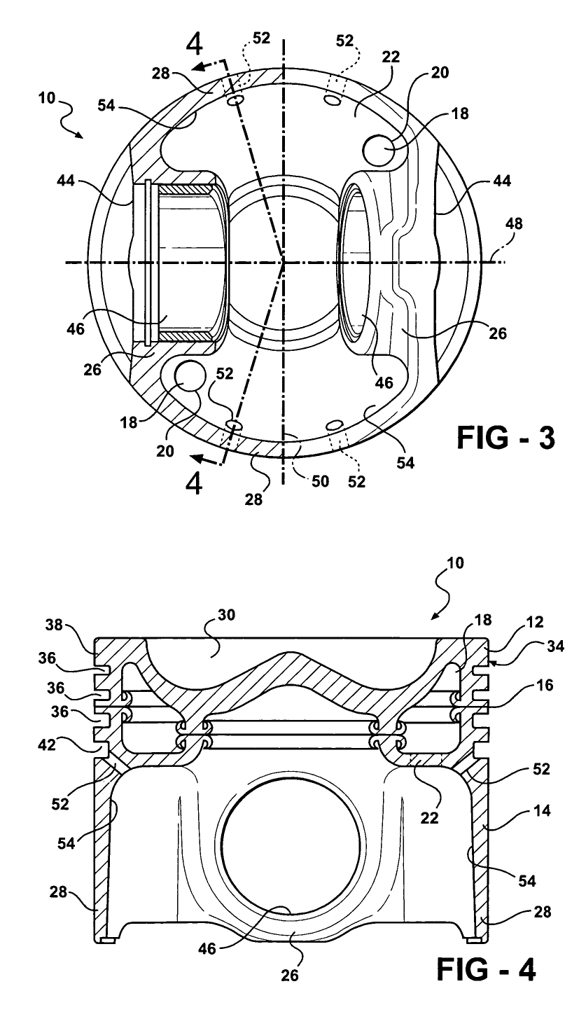

The pin bosses 26 are formed with pin bores 46 aligned along a pin bore axis 48 and adapted to receive a wrist pin (as shown) for coupling the piston 10 to a connecting rod (not shown). The pin bore axis 48 is perpendicular to a transverse axis 50 that bisects the skirt sections 28, as seen from the bottom view of FIG. 3. At least one and preferably a plurality of drain holes 52 are formed in the oil drainage groove 42 and open to the interior of the piston 10 below the oil gallery 18 for drainage back into the crank case from the interior of the piston inboard of the skirt sections 28. The at least one and preferably plurality of drain holes 52 are spaced circumferentially from the pin bosses 26. As shown best in FIGS. 1 and 3, there are preferably four such oil drainage holes 52 that extend from the fourth oil drainage groove 42 to the interior of the skirt sections 28. Preferably, the drain holes 52 are located 150 away from a vertical plane containing the transverse axis 50, and thus 30° from one another. While this arrangement is preferred, the invention contemplates other arrangements of the oil drainage holes 52 where optimizing the management of oil flow. As shown best in FIG. 2, the oil drainage holes 52 commence near the outer edge of the oil drainage groove 42 and extend inwardly and downwardly at about a 20° angle and open to the interior of the piston inwardly of the inner wall 54 of the skirt sections 28. Thus, in addition to the oil escaping from the oil drainage grooves 42 into the flat face regions 44 of the pin bosses 26, the oil can further drain through the drain holes 52 to enhance the oil draining function of the oil drainage groove 42.

Obviously, many modifications and variations of the present invention are possible in light of the above teachings. It is, therefore, to be understood that within the scope of the appended claims, the invention may be practiced otherwise than as specifically described.

What is claimed is:

1. A monobloc piston assembly comprising:
a piston head having a combustion bowl formed in an upper surface thereof and a ring belt formed with a plurality of ring grooves in an outer surface o said ring belt;
an oil cooling gallery formed in said piston head adjacent said combustion bowl and said ring belt;
a pair of pin bosses extending form said piston head;
a piston skirt formed as one immovable piece with said pin bosses;
an oil drainage groove formed below said ring groves; and
at least one drain hold formed in said oil drainage groove and open to an interior of said piston skirt.

2. The assembly of claim 1 including a plurality of said drain holes.

3. The assembly of claim 2 wherein said plurality of drain holes are spaced from one another and spaced radially from outer surfaces of said pin bosses.

4. The assembly of claim 3 wherein said plurality of drain holes includes four such drain holes.

5. The assembly of claim 4 wherein said plurality of drain holes are spaced about 15° away from a vertical plane containing a transverse axis that bisects said piston skirt.

6. The assembly of claim 1 wherein said at lest one drain hole extends inwardly and downwardly at an angle.

7. The assembly of claim 6 wherein said angle is about 20° from vertical.

8. A method of fabricating a monobloc piston comprising:
forming a piston head having a combustion bowl in a tip surface and forming a plurality of ring grooves in an outer surface of a ring belt;
forming an oil cooling gallery in the piston head and providing pin bores in a pair of pin bosses extending from the piston head opposite the combustion chamber;
forming a piston skirt as a one piece immovable structure relative to the piston body and pin bosses;
forming an oil drainage groove in the piston head that is continuous between the pin bosses and is discontinuous and open across the side surfaces of the pin bosses; and
forming at lest one drain hole in the oil drainage groove that opens to an interior of the piston skirt.
